(19) United States
(12) Patent Application Publication
(10) Pub. No.: US 2024/0254351 A1
(43) Pub. Date: Aug. 1, 2024

(54) UV LED Free Radical Curable Inkjet Inks

(71) Applicant: Agfa NV, Mortsel (BE)

(72) Inventors: Matthieu Retailleau, Mortsel (BE); Bart Waumans, Mortsel (BE)

(73) Assignee: Agfa NV, Mortsel (BE)

(21) Appl. No.: 18/565,605

(22) PCT Filed: May 30, 2022
(86) PCT No.: PCT/EP2022/064607

§ 371 Date: Nov. 30, 2023

(30) Foreign Application Priority Data
Jun. 1, 2021 (EP) 21177100.1

(51) Int. Cl. C09D 11/322; C09D 11/38; C09D 11/40

(52) U.S. Cl. CPC C09D 11/322; C09D 11/38; C09D 11/40

(57) ABSTRACT

A UV LED free radical curable inkjet ink containing an organic colour pigment; an acylphosphine oxide photoinitiator; monofunctional polymerizable compounds including vinyl methyl oxazolidinone; and one or more polyfunctional polymerizable compounds; wherein: the double bond density DD is between 5.28 and 5.78 mmol double bonds/g; the content of monofunctional polymerizable compounds is between 84 and 98 wt % based on the total weight of the polymerizable composition; and the content of vinyl methyl oxazolidinone is at least 13.3 wt % based on the total weight of the polymerizable composition.

### TECHNICAL FIELD

This invention relates to UV LED free radical curable inkjet inks that combine good scratch resistance and good adhesion, while exhibiting good surface curing, low odor and high printing reliability.

### BACKGROUND ART

The polymerizable composition of UV curable inkjet inks for a certain application usually results in a trade-off of certain ink properties. For example, good scratch resistance is obtained when the polymerizable composition contains a large amount of polyfunctional monomers compared to the monofunctional monomers. However, the latter generally results in poor flexibility, as illustrated by EP 2399965 A (AGFA).

A high content of polyfunctional monomers often also provides poor adhesion results, because polyfunctional monomers exhibit a much higher polymerization shrinkage than monofunctional monomers.

One approach for combining good scratch resistance and good adhesion is the use of specifically designed polyfunctional monomers. For example, WO 2005/055960 (DU PONT) discloses specific branched highly-functional monomers that exhibit low polymerization shrinkage. Such compounds often increase the viscosity of the polymerizable composition to a level still suitable for dental filling composites, but not for UV curable inkjet inks.

Another approach is to use inkjet inks that are curable by cationic polymerization, as such polymerization exhibits low shrinkage. However, it was found in industrial inkjet printing systems that cationically curable inkjet inks posed problems of jetting reliability due to UV stray light. The UV-curing of the ink causes reflections of UV light, including UV light hitting the nozzle plate of an inkjet print head and resulting into failing nozzles due to clogging by cured ink in the nozzle. Unlike free radical ink where radical species have a much shorter lifetime, the cationic curable ink continues to cure once an acid species has been generated by UV light in the nozzle.

There remains a need for UV LED free radical curable inkjet inks exhibiting good scratch resistance and good adhesion to a wide range of substrates, while exhibiting good surface curing, low odor and high printing reliability.

### SUMMARY OF INVENTION

In order to overcome the problems described above, preferred embodiments of the present invention provide a UV LED free radical curable inkjet ink containing an organic colour pigment; an acylphosphine oxide photoinitiator; monofunctional polymerizable compounds including vinyl methyl oxazolidinone; and one or more polyfunctional polymerizable compounds; wherein: the double bond density DD is between 5.28 and 5.78 mmol double bonds/g; the content of monofunctional polymerizable compounds is between 84 and 98 wt % based on the total weight of the polymerizable composition; and the content of vinyl methyl oxazolidinone is at least 13.3 wt % based on the total weight of the UV LED free radical curable inkjet ink; and wherein the double density DD is calculated by the formula:

$$D D = \frac{{\sum }_{i = 1 to n}^{n} \frac{F ( i ) \times wt \% ( i )}{M W ( i )}}{{\sum }_{i = 1 to n}^{n} wt \% ( i )}$$

wherein n represents the number of monomers and oligomers in the UV LED free radical curable inkjet ink; F(i) represents the functionality of monomer or oligomer i; MW(i) represents the molecular weight of monomer or oligomer i; and wt % (i) is the weight percentage of monomer or oligomer i based on the total weight of the polymerizable composition.

It was surprisingly found that by using a certain amount of a specific monofunctional monomer vinyl methyl oxazolidinone and controlling the double bond density DD between 5.28 and 5.78 mmol double bonds/g that good scratch resistance and adhesion could obtained with UV LED free radical curable inkjet inks containing a very high amount of monofunctional monomers and oligomers. The combination of the specific polymerizable composition with an acylphosphine oxide photoinitiator allowed to minimize stickiness due to incomplete surface cure. The use of vinyl methyl oxazolidinone also reduces the odor often observed with UV free radical curable inkjet inks.

Further advantages and preferred embodiments of the present invention will become apparent from the following description.

### DESCRIPTION OF EMBODIMENTS

### Definitions

The term “monofunctional polymerizable compound” means a polymerizable compound having only one polymerizable group, for example an acrylate group.

The term “polyfunctional polymerizable compound” means a monomer or oligomer having two, three or more polymerizable groups, e.g. two acrylate groups and one vinyl ether group.

### UV LED Free Radical Curable Inkjet Inks

A UV LED free radical curable inkjet ink according to a preferred embodiment of the present invention contains a colour pigment, preferably an organic colour pigment;
an acylphosphine oxide photoinitiator; monofunctional polymerizable compounds including vinyl methyl oxazolidinone; and one or more polyfunctional polymerizable compounds; wherein:
   the double bond density DD is between 5.28 and 5.78 mmol double bonds/g;
   the content of monofunctional polymerizable compounds is between 84 and 98 wt % based on the total weight of the polymerizable composition; and
the content of vinyl methyl oxazolidinone is at least 13.3 wt % based on the total weight of the UV LED free radical curable inkjet ink; and
wherein the double density DD is calculated by the formula:

$$D D = \frac{{\sum }_{i = 1 to n}^{n} \frac{F ( i ) \times wt \% ( i )}{M W ( i )}}{{\sum }_{i = 1 to n}^{n} wt \% ( i )}$$

wherein n represents the number of monomers and oligomers in the UV LED free radical curable inkjet ink; F(i) represents the functionality of monomer or oligomer i; MW(i) represents the molecular weight of monomer or oligomer i; and wt % (i) is the weight percentage of monomer or oligomer i based on the total weight of the polymerizable composition.

In a preferred embodiment of the UV LED free radical curable inkjet ink, the double bond density DD is preferably at least 5.50 or 5.60 and more preferably between 5.65 and 5.75 mmol double bonds/g. In this range the scratch resistance and adhesion is maximized.

The double bond density DD of a monomer or oligomer is obtained by dividing the functionality of the monomer or oligomer by the molecular weight (MW) of the monomer or oligomer. It is expressed in mmol double bonds/g. As an illustration, Table 1 here below shows the MW and the DD of some frequently used monomers in UV curable inkjet inks.

TABLE 1

| | MW | DD |
|---|---|---|
| Monomer/oligomer | (g/mol) | (mmol/g) |
| Vinyl methyl oxazolidinone | 127 | 7.87 |
| N-vinylcaprolactam | 139 | 7.19 |
| 4-Acryloylmorpholine | 141 | 7.09 |
| Tetrahydrofurfuryl acrylate | 156 | 6.41 |
| Octyl acrylate | 184 | 5.43 |
| 2(2-Ethoxyethoxy)-ethyl acrylate | 188 | 5.32 |
| Phenoxyethyl acrylate | 192 | 5.21 |
| 3,3,5-Trimethylcyclohexyl acrylate | 195 | 5.13 |
| Cyclic trimethylolpropane formal acrylate | 200 | 5.00 |
| (2-ethyl-2-methyl-1,3-dioxolan-4-yl)methyl acrylate | 200 | 5.00 |
| Isobornyl acrylate | 208 | 4.81 |
| 4-tert-butylcyclohexyl acrylate | 210 | 4.76 |
| Decyl acrylate | 212 | 4.72 |
| Isodecyl acrylate | 212 | 4.72 |
| Lauryl acrylate | 240 | 4.17 |
| 2-(2-vinyloxyethoxy)ethyl acrylate | 186 | 10.75 |
| Butanediol acrylate | 198 | 10.10 |
| Divinylether | 202 | 9.90 |
| 1,6-hexanediol diacrylate | 226 | 8.85 |
| Dipropylene glycol diacrylate | 252 | 7.94 |
| 1,10 decanediol diacrylate | 282 | 7.09 |
| Tricyclodecanedimethanol diacrylate | 304 | 6.58 |
| Propoxylated 2 neopentyl glycol diacrylate | 328 | 6.10 |
| Polyethylene glycol (400) diacrylate | 508 | 3.94 |
| Ethoxylated 4 bisphenol A diacrylate | 512 | 3.91 |
| CN963B80 | 1900 | 1.05 |
| Trimethylolpropane triacrylate | 296 | 10.14 |
| Tris (2-hydroxy ethyl) isocyanurate triacrylate | 423 | 7.09 |
| Pentaerythritol tetraacrylate | 352 | 11.36 |
| Ditrimethylolpropane Tetraacrylate | 482 | 8.30 |
| Dipentaerythritol pentaacrylate | 525 | 9.52 |

The content of monofunctional monomers in the UV LED free radical curable inkjet ink is at least 84 wt %, preferably between 90 and 98 wt %, more preferably between 94 and 97 wt % based on the total weight of the polymerizable composition in the UV LED free radical curable inkjet ink. In the latter ranges the polymerization shrinkage is minimized, which is beneficial for adhesion.

The UV LED free radical curable inkjet ink contains at least 13.3 wt %, vinyl methyl oxazolidinone based on the total weight of the UV LED free radical curable inkjet ink.

In a preferred embodiment, it preferably also contains N-vinylcaprolactam, as the combination vinyl methyl oxazolidinone and N-vinylcaprolactam may improve the adhesion further. The amount of vinyl methyl oxazolidinone and N-vinylcaprolactam in the UV LED free radical curable inkjet ink is preferably at least 20 wt %, more preferably at least 24 wt % based on the total weight of the UV LED free radical curable inkjet ink.

The UV LED free radical curable inkjet ink most preferably contains no organic solvents, but may contain organic solvents in an amount of 0 to 20 wt %, preferably 0 to 10 wt %, more preferably 0 to 5 wt % based on the total weight of the UV LED free radical curable inkjet ink.

In another preferred embodiment of the UV LED free radical curable inkjet ink, the inkjet ink contains vinyl methyl oxazolidinone and no N-vinylcaprolactam, because N-vinylcaprolactam was found to cause respiratory irritation and can cause damage to organs through prolonged or repeated exposure.

In a preferred embodiment, the UV LED free radical curable inkjet ink contains 10 to 23 wt % of isobornyl acrylate based on the total weight of the UV LED free radical curable inkjet ink. In such a range, isobornyl acrylate improves the scratch resistance.

In a preferred embodiment, the UV LED free radical curable inkjet ink contains more than 42 wt % of isobornyl acrylate and phenoxyethyl acrylate based on the total weight of the UV LED free radical curable inkjet ink. Such amounts are beneficial for adhesion and stickiness.

The kinematic viscosity of the UV LED free radical curable inkjet ink is preferably between between 4 and 12 mm²/s as measured at 45° C. In this range a high print reliability is observed with piezoelectric print heads.

The surface tension of the UV LED free radical curable inkjet ink is preferably in the range of 20 mN/m to 30 mN/m at 25° C., more preferably in the range of about 22 mN/m to about 25 mN/m at 25° C.

The UV LED free radical curable inkjet ink may further also contain at least one inhibitor or stabilizer for improving the thermal stability of the ink, which improves the printing reliability.

The UV LED free radical curable inkjet ink may further also contain at least one surfactant for obtaining good spreading characteristics on a substrate.

### Inkjet Ink Sets

For printing multi-colour images, the UV LED free radical curable inkjet ink is part of an inkjet ink set. The multi-colour images can be used indoor, but may also be used outdoor. For the latter case, organic colour pigments were selected to provide a high light stability with the polymerizable composition of the UV LED free radical curable inkjet ink as described above.

A preferred inkjet ink set includes a cyan UV LED free radical curable inkjet ink containing a beta-copper phthalocyanine pigment; a black UV LED free radical curable inkjet ink containing a carbon black pigment; a magenta or red UV LED free radical curable inkjet ink containing a quinacridone pigment, a diketopyrrolopyrrole pigment or mixed crystals thereof; and a yellow UV LED free radical curable inkjet ink containing a yellow pigment selected from the group consisting of C.I. Pigment Yellow 83, C.I. Pigment Yellow 93, C.I. Pigment Yellow 97, C.I. Pigment Yellow 110, C.I. Pigment Yellow 120, C.I. Pigment Yellow 150, C.I. Pigment Yellow 151, C.I. Pigment Yellow 154, C.I. Pigment Yellow 155, C.I. Pigment Yellow 175, C.I. Pigment Yellow 180, C.I. Pigment Yellow 181, C.I. Pigment Yellow 194, C.I. Pigment Yellow 213, C.I. Pigment Yellow 214 and mixed crystals thereof.

In a particularly preferred embodiment of the ink set, the cyan, black, magenta or red, and yellow UV LED free radical curable inkjet inks all have an ink composition as described above.

The inkjet ink set is preferably a UV LED curable CMYK or CRYK inkjet ink set. This UV LED free radical curable inkjet ink set may also be extended with extra inks such as red, green, blue, and/or orange to further enlarge the colour gamut of the image. The UV curable inkjet ink set may also be extended by the combination of full density inkjet inks with light density inkjet inks. The combination of dark and light colour inks and/or black and grey inks improves the image quality by a lowered graininess.

The inkjet ink set may also include a colourless UV LED free radical curable inkjet ink, such as a varnish. A varnish is used to enhance the glossiness of inkjet printed colour images.

The inkjet ink set preferably also includes a white UV LED free radical curable inkjet ink. The white UV LED free radical curable inkjet ink preferably contains a titanium dioxide pigment, preferably a rutile pigment, having an average particle size larger than 180 nm, preferably between 200 and 280 nm, more preferably between 220 and 250 nm.

White inkjet inks are generally used for so-called “surface printing” or “backing printing” to form a reflection image on a transparent substrate. In surface printing, a white background is formed on a transparent substrate using a white ink and further thereon, a colour image is printed, where after the formed final image is viewed from the printed face. In so-called backing printing, a colour image is printed on a transparent substrate using colour inks and then a white ink is applied onto the colour inks, and the colour image is observed through the transparent substrate.

A white inkjet ink preferably includes a pigment with a high refractive index, preferably a refractive index greater than 1.60, preferably greater than 2.00, more preferably greater than 2.50 and most preferably greater than 2.60. Such white pigments generally have a very high covering power, i.e. a limited amount of white ink is necessary to hide the colour and defects of the core layer. The most preferred white pigment is titanium dioxide.

The white inkjet ink preferably contains the white pigment in an amount of 8 wt % to 25 wt %, more preferably 12 to 20 wt % of white pigment based upon the total weight of the white inkjet ink.

The average particle diameter of the white pigment is preferably from 150 to 500 nm, and most preferably from 180 to 300 nm. Sufficient hiding power cannot be obtained when the average diameter is less than 150 nm, and the storage ability and the jet-out suitability of the ink tend to be degraded when the average diameter exceeds 500 nm.

### Acylphosphine Oxide Photoinitiators

The UV LED free radical curable inkjet ink contains at least an acylphosphine oxide photoinitiator, preferably present in an amount of at least 4.0 wt %, more preferably in an amount of 5.0 to 16.0 wt % based on the total weight of the UV LED free radical curable inkjet ink.

Preferred examples of the acylphosphine oxide photoinitiators include bis(2,4,6-trimethylbenzoyl)-phenyl phosphine oxide, 2,4,6-trimethylbenzoyl diphenyl phosphine oxide, and ethyl (2,4,6-trimethylbenzoyl) phenyl phosphinate, bis-(2,6-dimethoxybenzoyl) 2,4,4-trimethylpentyl phosphine oxide. Such acylphosphine oxide photoinitiators are commercially available, for example, as Omnirad™ 819, Omnirad™ TPO and Omnirad™ TPO-L from IGM Resins.

The acylphosphine oxide may also be a polymeric compound, such as Omnipol™ TP from IGM Resins.

When the one or more UV LED free radical curable inkjet inks are used for an indoor application, such as indoor decoration, the acylphosphine oxide photoinitiator includes an acyl group containing a polymerizable group or an acyl group selected from the group consisting of a benzoyl group substituted by an urea group or an oxalylamide group; a 2,6-dimethyl benzoyl group substituted in position 3 by an urea group or an oxalylamide group; a 2,6-dimethoxy benzoyl group substituted in position 3 by an urea group or an oxalylamide group; a 2,4,6-trimethyl benzoyl group substituted in position 3 by an urea group or an oxalylamide group; and a 2,4,6-trimethoxybenzoyl group substituted in position 3 by an urea group or an oxalylamide group. By using such an acylphosphine oxide photoinitiator, no mesitaldehyde is released after UV curing, which causes a bad odor of the printed article.

Suitable acylphosphine oxide photoinitiators having an acyl group substituted by an urea group or an oxalylamide group are disclosed in WO 2019/243039 (AGFA).

Suitable acylphosphine oxide photoinitiators including an acyl group containing a polymerizable group are disclosed by WO 2014/051026 (FUJIFILM).

A combination of different acylphosphine oxide photoinitiators may also be used. For example, a combination of monofunctional acylphosphine oxide photoinitiators, such as TPO and TPO-L, and multifunctional acylphosphine oxide photoinitiators, such as bis(2,4,6-trimethylbenzoyl)-phenyl phosphine oxide. Preferably such a combination contains more monofunctional acylphosphine oxide photoinitiator than multifunctional acylphosphine oxide photoinitiator. A combination containing at least 70 wt % of monofunctional acylphosphine oxide photoinitiator generally exhibits a higher curing efficiency.

Alternatively, the acylphosphine oxide is a polymeric compound wherein the acylphosphine oxido structure is bonded to a polymeric chain on an acyl group side thereof. Suitable compounds are disclosed in WO 2014/129213 (FUJIFILM). By having the acyl group bonded to the polymeric chain, the odor of the printed article is also suppressed.

### Other Photoinitiators

Other photoinitiators may be present in the UV LED free radical curable inkjet ink, preferably a Norrish type I initiator or a Norrish type II initiator. A Norrish Type I initiator is an initiator which cleaves after excitation, yielding the initiating radical immediately. A Norrish type II-initiator is a photoinitiator which is activated by actinic radiation and forms free radicals by hydrogen abstraction from a second compound that becomes the actual initiating free radical. This second compound is called a polymerization synergist or a co-initiator.

Suitable other photo-initiators are disclosed in CRIVELLO, J. V., et al. VOLUME III: Photoinitiators for Free Radical Cationic. 2nd edition. Edited by BRADLEY, G. London, UK: John Wiley and Sons Ltd, 1998. p. 287-294.

### Norrish Type I Photoinitiators

In addition to the acylphosphine oxide photoinitiator as Norrish Type I photoinitiator, a second Norrish Type I photoinitiator is preferably selected from the group consisting of benzoinethers, benzil ketals, α-haloketones, α,α-dialkoxyaceto phenones, α-hydroxyalkylphenones, α-halosulfones, α-aminoalkylphenones, acylphosphine sulphides and phenylglyoxalates.

In a preferred embodiment, the other photoinitiator is an α-hydroxy ketone photoinitiator.

Suitable examples of the α-hydroxy ketone photoinitiators include, but are not particularly limited to, 1-hydroxycyclohexyl phenyl ketone, 2-hydroxy-2-methyl-1-phenyl propane-1-one and 1-[4-(2-hydroxyethoxy)-phenyl]2-hydroxy-2-methyl-1-propane-1-on.

Examples of commercially α-hydroxy ketone photoinitiators include, but are not particularly limited to, Omnirad™ 1173, Omnirad™ 184 and Omnirad™ 127 and Omnirad™ 4817 from IGM RESINS.

The content of the α-hydroxy ketone is preferably 1 to 10 wt %, more preferably 2 to 8 wt %, and still more preferably 3 to 6 wt % based on the total weight of the UV LED free radical curable inkjet ink.

Ina particularly preferred embodiment, the α-hydroxy ketone photoinitiator is a polymeric or a polymerizable photoinitiator.

An example of a suitable polymeric α-hydroxy ketone photoinitiator is available as Esacure™ KIP150 from IGM RESINS.

Suitable polymerizable α-hydroxy ketone photoinitiators are disclosed in U.S. Pat. No. 4,922,004 (MERCK), such as 4-(2-acryloyloxyethoxy)-phenyl 2-acryloyloxy-2-propyl ketone prepared in Example 3.

### Norrish Type II Photoinitiators

The UV LED free radical curable inkjet ink preferably contains a Norrish Type II photoinitiator including a photoinitiating moiety selected from the group consisting of a thioxanthone group, a carbazole group and a benzophenone group. A Norrish Type II photoinitiator containing a thioxanthone group or a carbazole group is particularly preferred as it is advantageous for UV LED curing, especially for UV LEDs having an emission wavelength of 360 nm or even 370 nm.

Suitable examples of Norrish Type II photoinitiators containing a thioxanthone group include, but are not particularly limited to, thioxanthone; diethylthioxanthone, such as 2,4-diethylthioxanthone: isopropylthioxanthone, such as 2-isopropylthioxanthone and 4-isopropylthioxanthone; and chlorothioxanthone, such as 2-chlorothioxanthone.

Specific examples of commercially available Norrish Type II photoinitiators containing a thioxanthone group are Speedcure™ DETX (2,4-diethylthioxanthone) and Speedcure™ ITX (2-isopropylthioxanthone) from LAMBSON and Kayacure™ DETX-S(2,4-diethylthioxanthone) from Nippon Kayaku Co.

Preferred carbazole photoinitiators are disclosed by EP 2509948 A (AGFA) These carbazole photoinitiators have the advantage over thioxanthone photoinitiators of exhibiting less photoyellowing.

Suitable examples of Norrish Type II photoinitiators containing a benzophenone group include, but are not particularly limited to, benzophenone; methylbenzophenone; methyl-2-benzoylbenzoate, phenylbenzophenone, such as 4-phenylbenzophenone; trimethylbenzophenone; bis(alkylamino)benzophenone; and 4-(dialkylamino)benzophenone.

Specific examples of commercially available Norrish Type II photoinitiators containing a benzophenone group are Omnirad™ 4 MBZ and Omnirad™ BP from IGM RESINS, Speedcure™ PBZ and Speedcure™ 5040 from LAMBSON. The latter is a mixture of benzophenone and thioxanthone.

Preferred examples of polymerizable Norrish Type II photoinitiators including a photoinitiating moiety selected from the group consisting of a thioxanthone group or a benzophenone group are disclosed in EP 2161264 A (AGFA), EP 2199273 A (AGFA) and EP 2684876 A (AGFA).

Preferred examples of polymeric Norrish Type II photoinitiators including a photoinitiating moiety selected from the group consisting of a thioxanthone group or a benzophenone group are disclosed in EP 1616920 A (AGFA) and EP 1616899 A (AGFA).

Commercial examples of polymeric thioxanthones and benzophenones include Omnipol™ BP, Omnipol™ TX, and Omnipol™ 2702 from IGM RESINS.

The content of the Norrish Type II photoinitiator including a photoinitiating moiety selected from the group consisting of a thioxanthone group, a carbazole group and a benzophenone group is preferably 0.5 to 7.5 wt %, more preferably 1 to 5 wt % based on the total weight of the free radical curable inkjet ink. However, if the Norrish Type II photoinitiator is a polymerizable or a polymeric thioxanthone compound, the content may be higher, preferably up to 25 wt %, more preferably up to 15 wt % based on the total weight of the free radical curable inkjet ink.

### Polymerization Synergists

In order to increase the photosensitivity further, the UV LED free radical curable inkjet ink may additionally contain one or more co-initiators, also called polymerization synergists, for which usually amine synergists are used.

Suitable examples of amine synergists can be categorized in three groups:
1) tertiary aliphatic amines such as methyldiethanolamine, dimethylethanolamine, triethanolamine, triethylamine and N-methylmorpholine;
(2) aromatic amines such as amylparadimethylaminobenzoate, 2-n-butoxyethyl-4-(dimethylamino) benzoate, 2-(dimethylamino)ethylbenzoate, ethyl-4-(dimethylamino)benzoate, and 2-ethylhexyl-4-(dimethylamino)benzoate; and
(3) (meth)acrylated amines such as dialkylamino alkyl(meth)acrylates (e.g., diethylaminoethylacrylate) or N-morpholinoalkyl-(meth)acrylates (e.g., N-morpholinoethyl-acrylate).

In a preferred embodiment of the UV LED free radical curable inkjet ink, the polymerization synergist is an acrylated amine synergist.

Suitable amine synergists are commercially available as Omnipol™ ASA, Omnipol™ 894 nad Esacure™ A198 from IGM Resins.

Preferred commercial acrylated amine synergists include Photomer™ 4068, 4250, 4771, 4775, 4780, 4967 and 5006 from IGM Resins.

### Colour Pigments

The UV LED free radical curable inkjet ink contains a colour pigment, preferably an organic colour pigment. Organic colour pigments provide a far larger colour gamut than inorganic colour pigment, but are more susceptible to light fading. The colour gamut represents the number of different colours that can be produced by an ink set.

The colour pigments may be black, cyan, magenta, yellow, red, orange, violet, blue, green, brown, mixtures thereof, and the like. A colour pigment may be chosen from those disclosed by HERBST, Willy, et al. Industrial Organic Pigments, Production, Properties, Applications. 3rd edition. Wiley—VCH, 2004. ISBN 3527305769.

A particularly preferred pigment for a cyan inkjet ink is C.I. Pigment Blue 60 or preferably a beta copper phthalocyanine pigment, more preferably C.I. Pigment Blue 15:3 or C.I. Pigment Blue 15:4.

A magenta or red UV LED free radical curable inkjet ink preferably contains a quinacridone pigment, a diketopyrrolopyrrole pigment or mixed crystals thereof. In a preferred embodiment, the magenta or red UV LED free radical curable inkjet ink preferably contains a pigment selected from the group consisting of C.I. Pigment Violet 19, C.I. Pigment Red 122, C.I. Pigment Red 144, C.I. Pigment Red 176, C.I. Pigment Red 188, C.I. Pigment Red 207, C.I. Pigment Red 242, C.I. Pigment Red 254, C.I. Pigment Red 272 and mixed crystals thereof.

A yellow free radical curable inkjet ink preferably contains a yellow pigment selected from the group consisting of C.I. Pigment Yellow 83, C.I. Pigment Yellow 93, C.I. Pigment Yellow 97, C.I. Pigment Yellow 110, C.I. Pigment Yellow 120, C.I. Pigment Yellow 138, C.I. Pigment Yellow 150, C.I. Pigment Yellow 151, C.I. Pigment Yellow 154, C.I. Pigment Yellow 155, C.I. Pigment Yellow 175, C.I. Pigment Yellow 180, C.I. Pigment Yellow 181, C.I. Pigment Yellow 185, C.I. Pigment Yellow 194, C.I. Pigment Yellow 213, C.I. Pigment Yellow 214 and mixed crystals thereof.

The above selected organic colour pigments for the cyan, magenta, red or yellow inkjet inks exhibit minimal light fading in the combination with a polymerizable composition as described above.

For a black ink, suitable pigment materials include carbon blacks such as Regal™ 400R, Mogul™ L, Elftex™ 320 from Cabot Co., or Carbon Black FW18, Special Black™ 250, Special Black™ 350, Special Black™ 550, Printex™ 25, Printex™ 35, Printex™ 55, Printex™ 90, Printex™ 150T from DEGUSSA Co., MA8 from MITSUBISHI CHEMICAL Co., and C.I. Pigment Black 7 and C.I. Pigment Black 11.

Also mixed crystals may be used. Mixed crystals are also referred to as solid solutions. For example, under certain conditions different quinacridones mix with each other to form solid solutions, which are quite different from both physical mixtures of the compounds and from the compounds themselves. In a solid solution, the molecules of the components enter into the same crystal lattice, usually, but not always, that of one of the components. The x-ray diffraction pattern of the resulting crystalline solid is characteristic of that solid and can be clearly differentiated from the pattern of a physical mixture of the same components in the same proportion. In such physical mixtures, the x-ray pattern of each of the components can be distinguished, and the disappearance of many of these lines is one of the criteria of the formation of solid solutions. A commercially available example is Cinquasia™ Magenta RT-355-D from Ciba Specialty Chemicals.

Also mixtures of pigments may be used. For example, a black inkjet ink may include a carbon black pigment and at least one pigment selected from the group consisting of a blue pigment, a cyan pigment, a magenta pigment and a red pigment. It was found that such a black inkjet ink allowed easier and better colour management for wood colours.

The pigment particles in the pigmented inkjet ink should be sufficiently small to permit free flow of the ink through the inkjet printing device, especially at the ejecting nozzles. It is also desirable to use small particles for maximum colour strength and to slow down sedimentation.

The average particle size of the pigment in the pigmented inkjet ink should preferably be between 0.05 μm and 0.5 μm, more preferably between 0.08 and 0.3 μm, most preferably between 0.1 and 0.2 μm.

The pigment is used in the inkjet ink in an amount of 0.1 to 20 wt %, preferably 1 to 10 wt %, and most preferably 2 to 6 wt % based on the total weight of the UV LED free radical inkjet ink. A pigment concentration of at least 2 wt % is preferred to reduce the amount of inkjet ink needed to produce a colour pattern, while a pigment concentration higher than 5 wt % reduces the colour gamut and increases the graininess for printing the colour pattern. The ink set may also contain a light density inkjet ink. In such a case the light density inkjet ink contains a pigment in an amount of preferably 0.1 to 1.0 wt %, more preferably 0.5 to 0.8 wt % based on the total weight of the UV LED free radical inkjet ink.

The determination of the average particle diameter is best performed by photon correlation spectroscopy at a wavelength of 633 nm with a 4 mW HeNe laser on a diluted sample of the pigmented inkjet ink. A suitable particle size analyzer used was a Malvern™ nano-S available from Goffin-Meyvis. A sample can, for example, be prepared by addition of one drop of ink to a cuvet containing 1.5 mL ethyl acetate and mixed until a homogenous sample was obtained. The measured particle size is the average value of 3 consecutive measurements consisting of 6 runs of 20 seconds.

### Dispersants

The pigmented free radical curable inkjet ink contains a dispersant in order to further improve pigment dispersion properties. For obtaining high printing reliability, the dispersant is preferably a polymeric dispersant. Such dispersant improves the reliability of the inkjet printing process due to a generally smaller sedimentation speed, especially when they contain secondary or tertiary amine groups.

Typical polymeric dispersants are copolymers of two monomers but may contain three, four, five or even more monomers. The properties of polymeric dispersants depend on both the nature of the monomers and their distribution in the polymer. Copolymeric dispersants preferably have the following polymer compositions:
statistically polymerized monomers (e.g. monomers A and B polymerized into ABBAABAB);
alternating polymerized monomers (e.g. monomers A and B polymerized into ABABABAB);
gradient (tapered) polymerized monomers (e.g. monomers A and B polymerized into AAABAABBABBB);
block copolymers (e.g. monomers A and B polymerized into AAAAABBBBBB) wherein the block length of each of the blocks (2, 3, 4, 5 or even more) is important for the dispersion capability of the polymeric dispersant;
graft copolymers (graft copolymers consist of a polymeric backbone with polymeric side chains attached to the backbone); and
mixed forms of these polymers, e.g. blocky gradient copolymers.

The polymeric dispersant has preferably a number average molecular weight Mn between 500 and 30000, more preferably between 1500 and 10000.

The polymeric dispersant has preferably a weight average molecular weight Mw smaller than 100,000, more preferably smaller than 50,000 and most preferably smaller than 30,000.

The polymeric dispersant has preferably a polydispersity PD smaller than 2, more preferably smaller than 1.75 and most preferably smaller than 1.5.

Commercial examples of polymeric dispersants are the following:
DISPERBYK™ dispersants available from BYK CHEMIE GMBH;
SOLSPERSE™ dispersants available from LUBRIZOL;
TEGO™ DISPERS™ dispersants from EVONIK;
EDAPLAN™ dispersants from MUNZING CHEMIE;
ETHACRYL™ dispersants from LYONDELL;
GANEX™ dispersants from ISP;
DISPEX™ and EFKA™ dispersants from BASF;
DISPONER™ dispersants from DEUCHEM.

Particularly preferred polymeric dispersants include Solsperse™ dispersants from LUBRIZOL, Efka™ dispersants from BASF, Disperbyk™ dispersants from BYK CHEMIE GMBH, and Ajisper™ dispersants from AJINOMOTO FINE-TECHNO Co. Particularly preferred dispersants are Solsperse™ 32000, 35000 and 39000 dispersants from LUBRIZOL and Disperbyk™ 162 from BYK CHEMIE GMBH.

The dispersants may be used alone or in combination of two or more kinds thereof.

The polymeric dispersant is preferably used in an amount of 2 to 600 wt %, more preferably 5 to 200 wt %, most preferably 50 to 90 wt % based on the weight of the pigment.

### Dispersion Synergists

The UV LED free radical curable inkjet ink may include a dispersion to further improve the dispersion stability by a polymeric dispersant and thus also the printing reliability as less pigment can sediment in the nozzle of a print head upon stand-by of an inkjet device.

A dispersion synergist usually consists of an anionic part and a cationic part. The anionic part of the dispersion synergist exhibiting a certain molecular similarity with the colour pigment and the cationic part of the dispersion synergist consists of one or more protons and/or cations to compensate the charge of the anionic part of the dispersion synergist.

The dispersion synergist is preferably added in a smaller amount than the polymeric dispersant(s). The ratio of polymeric dispersant/dispersion synergist depends upon the pigment and should be determined experimentally. Typically, the ratio wt % polymeric dispersant/wt % dispersion synergist is selected between 2:1 to 100:1, preferably between 2:1 and 20:1.

Suitable dispersion synergists that are commercially available include Solsperse™ 5000 and Solsperse™ 22000 from LUBRIZOL.

Particular preferred pigments for the magenta ink used are a diketopyrrolo-pyrrole pigment or a quinacridone pigment. Suitable dispersion synergists include those disclosed in EP 1790698 A (AGFA GRAPHICS), EP 1790696 A (AGFA GRAPHICS), WO 2007/060255 (AGFA GRAPHICS) and EP 1790695 A (AGFA GRAPHICS).

In dispersing C.I. Pigment Blue 15:3, the use of a sulfonated Cu-phthalocyanine dispersion synergist, e.g. Solsperse™ 5000 from LUBRIZOL is preferred. Suitable dispersion synergists for yellow inkjet inks include those disclosed in EP 1790697 A (AGFA GRAPHICS).

### Monofunctional Monomers and Oligomers

The monofunctional monomers and oligomers include at least vinyl methyl oxazolidinone, but preferably contain also other monofunctional monomers and oligomers, such as N-vinylcaprolactam.

There is no real limitation on the other monofunctional monomers and oligomers. Any monofunctional monomer and oligomer capable of free radical polymerization may be used as the other monofunctional polymerizable compound. Suitable other monofunctional monomers and oligomers may be any monofunctional monomer or oligomer found in the Polymer Handbook Vol 1+2, 4th edition, edited by J. BRANDRUP et al., Wiley-Interscience, 1999.

In a preferred embodiment, the other monofunctional monomer and oligomer includes an ethylenically unsaturated polymerizable group selected from the group consisting of an acrylate, a methacrylate, an acrylamide, a methacrylamide, a styrene group, a maleate, a fumarate, an itaconate, a vinyl ether, a vinyl ester, an allyl ether and an allyl ester.

In a more preferred embodiment, the other monofunctional monomer and oligomer is a monoacrylate, preferably selected from the group consisting of isoamyl acrylate, stearyl acrylate, lauryl acrylate, octyl acrylate, decyl acrylate, isoamylstyl acrylate, isostearyl acrylate, 2-ethylhexyl-diglycol acrylate, 2-hydroxybutyl acrylate, 2-acryloyloxyethylhexahydrophthalic acid, butoxyethyl acrylate, ethoxydiethylene glycol acrylate, methoxydiethylene glycol acrylate, methoxypolyethylene glycol acrylate, methoxypropylene glycol acrylate, phenoxyethyl acrylate, tetrahydrofurfuryl acrylate, isobornyl acrylate, cyclic trimethylolpropane formal acrylate, 3,3,5-trimethylcyclohexyl acrylate, 2-hydroxyethyl acrylate, 2-hydroxypropyl acrylate, 2-hydroxy-3-phenoxypropyl acrylate, 2-acryloyloxyethylsuccinic acid, 2-acryloyxyethylphthalic acid, 2-acryloxyethyl-2-hydroxyethyl-phthalic acid, lactone modified flexible acrylate, and t-butylcyclohexyl acrylate,

Acrylamides or substituted acrylamides can also be used as the other monofunctional monomer and oligomer.

The other monofunctional monomer or oligomer is preferably present in an amount of 20 to 80 wt %, more preferably 30 to 70 wt % based on the total weight of the UV LED free radical curable inkjet ink.

### Polyfunctional Monomers and Oligomers

The UV LED free radical curable inkjet ink includes also a polyfunctional polymerizable compound for obtaining good scratch resistance. A polyfunctional monomer or oligomer is preferably present in an amount of 2 to 10 wt %, more preferably 3 to 6 wt % based on the total weight of the polymerizable composition.

There is no real limitation on the other monofunctional monomers and oligomers. Any polyfunctional monomer and oligomer capable of free radical polymerization may be used as the polyfunctional polymerizable compound. Suitable polyfunctional monomers and oligomers may be any polyfunctional monomer or oligomer found in the Polymer Handbook Vol 1+2, 4th edition, edited by J. BRANDRUP et al., Wiley-Interscience, 1999.

Polyfunctional monomers and oligomers may be selected from the group consisting of triethylene glycol diacrylate, tetraethylene glycol diacrylate, polyethylene glycol diacrylate, dipropylene glycol diacrylate, tripropylene glycol diacrylate, polypropylene glycol diacrylate, 1,4-butanediol diacrylate, 1,6-hexanediol diacrylate, 1,9-nonanediol diacrylate, neopentyl glycol diacrylate, dimethylol-tricyclodecane diacrylate, bisphenol A EO (ethylene oxide) adduct diacrylate, bisphenol A PO (propylene oxide) adduct diacrylate, hydroxypivalate neopentyl glycol diacrylate, propoxylated neopentyl glycol diacrylate, alkoxylated dimethyloltricyclodecane diacrylate and polytetramethylene glycol diacrylate, trimethylolpropane triacrylate, EO modified trimethylolpropane triacrylate, tri (propylene glycol) triacrylate, caprolactone modified trimethylolpropane triacrylate, pentaerythritol triacrylate, pentaerithritol tetraacrylate, pentaerythritolethoxy tetraacrylate, dipentaerythritol hexaacrylate, ditrimethylolpropane tetraacrylate, glycerinpropoxy triacrylate, alkoxylated cyclohexanone dimethanol diacrylate, caprolactam modified dipentaerythritol hexaacrylate, alkoxylated cyclohexanone dimethanol diacrylate, alkoxylated hexanediol diacrylate, dioxane glycol diacrylate, dioxane glycol diacrylate, cyclohexanone dimethanol diacrylate, diethylene glycol diacrylate, neopentyl glycol diacrylate, vinylether acrylates, propoxylated glycerine triacrylate and propoxylated trimethylolpropane triacrylate, di-trimethylolpropane tetraacrylate, dipentaerythritol pentaacrylate, ethoxylated pentaeryhtitol tetraacrylate, methoxylated glycol acrylates and acrylate esters.

Preferred vinylether acrylates are those disclosed in U.S. Pat. No. 6,310,115 (AGFA). A particularly preferred compound is 2-(2-vinyloxyethoxy)ethyl acrylate. Other suitable vinylether acrylates are those disclosed in columns 3 and 4 of U.S. Pat. No. 6,767,980 B (NIPPON SHOKUBAI).

In a particularly preferred embodiment, the UV LED free radical curable inkjet ink contains a polyfunctional polymerizable compound selected from dipropylene glycol diacrylate, tricyclodecanedimethanol diacrylate and 1,6-hexanediol diacrylate.

### Polymerization Inhibitors

The UV LED free radical curable inkjet ink may also contain a polymerization inhibitor. Due to the fact that an ink contains the polymerization inhibitor, a polymerization reaction before curing, e.g. during storage or transport, can be prevented. It also improves the printing reliability, since the UV LED free radical curable inkjet ink in a print head of an inkjet device is kept at a higher temperature such as 45 to 55° C.

Suitable polymerization inhibitors include phenol type antioxidants, hindered amine light stabilizers, phosphor type antioxidants, benzoquinone, hydroquinone and derivatives, such as hydroquinone monomethyl ether commonly used in (meth)acrylate monomers.

Examples of the phenolic polymerization inhibitor include, but are not limited to the following substances, p-methoxy phenol, cresol, t-butyl catechol, di-t-butyl-p-cresol, hydroquinone monomethylether, a-naphthol, 3,5-di-t-butyl-4-hydroxytoluene, 2,6-di-t-butyl-4-methylphenol, 2,2′-methylene-bis(4-methyl-6-t-butylphenol), 2,2′-methylene-bis(4-ethyl-6-butylphenol), and 4,4′-thio-bis(3-methyl-6-t-butylphenol) and pyrogallol.

Suitable commercial inhibitors are, for example, Sumilizer™ GA-80, Sumilizer™ GM and Sumilizer™ GS produced by Sumitomo Chemical Co. Ltd.; Genorad™ 16, Genorad™ 18 and Genorad™ 20 from Rahn AG; Irgastab™ UV10 and Irgastab™ UV22, Tinuvin™ 460 and CGS20 from Ciba Specialty Chemicals; Floorstab™ UV range (UV-1, UV-2, UV-5 and UV-8) from Kromachem Ltd, Additol™ S range (S100, 5110, S120 and S130) from Cytec Surface Specialties.

A preferred polymerization inhibitor is Irgastab™ UV10 from BASF. Other examples of polymerization inhibitor include TEMPO, TEMPOL, and Al cupferron.

The polymerization inhibitors may be used alone or in combination of two or more kinds thereof.

In a preferred embodiment, the polymerization inhibitor is a mixture of different types of polymerization inhibitors. Preferred polymerization inhibitors are mixtures of an oxyl free radical-based polymerization inhibitor, a phenol-based polymerization inhibitor, and an amine-based polymerization inhibitor. Suitable examples are given in EP 2851402 A (FUJIFILM).

The polymerization inhibitor is preferably present in an amount of 0.1 to 5 wt % based on the total weight of the UV LED free radical curable inkjet ink. Below 0.1 wt %, the undesired polymerization is insufficiently inhibited and above 5 wt % the curing speed is heavily reduced.

### Surfactants

The UV LED free radical curable inkjet ink may contain a surfactant. The surfactant can be anionic, cationic, non-ionic, or zwitter-ionic. The surfactant is preferably present in an amount of 0.1 to 3 wt % based on the total weight of the UV LED free radical curable inkjet ink. At higher concentrations than 3 wt %, the adhesion may deteriorate rapidly, while usually insufficient spreading of the ink is observed at concentration lower than 0.1 wt %.

The total quantity of surfactant is preferably less than 3 wt % based on the total weight of the ink and more preferably less than 1.5 wt % based on the total weight of the free radical curable inkjet ink to prevent foaming of the ink in its container. Such foaming has a negative impact on the printing reliability.

Preferred surfactants are selected from fluoro surfactants (such as fluorinated hydrocarbons) and silicone surfactants. The silicone surfactants are preferably siloxanes and can be alkoxylated, polyester modified, polyether modified, polyether modified hydroxy functional, amine modified, epoxy modified and other modifications or combinations thereof. Preferred siloxanes are polymeric, for example polydimethylsiloxanes.

Preferred commercial silicone surfactants include BYK™ 333 and BYK™ UV3510 from BYK Chemie and Tegoglide™ 410 from EVONIK.

In a preferred embodiment, the surfactant is a polymerizable compound.

Preferred polymerizable silicone surfactants include a (meth)acrylated silicone surfactant. Most preferably the (meth)acrylated silicone surfactant is an acrylated silicone surfactant, because acrylates are more reactive than methacrylates.

In a preferred embodiment, the (meth)acrylated silicone surfactant is a polyether modified (meth)acrylated polydimethylsiloxane or a polyester modified (meth)acrylated polydimethylsiloxane.

Preferred commercially available (meth)acrylated silicone surfactants include: Ebecryl™ 350, a silicone diacrylate from Cytec; the polyether modified acrylated polydimethylsiloxane BYK™ UV3500, BYK™ UV3510 and BYK™ UV3530, the polyester modified acrylated polydimethylsiloxane BYK™ UV3570, all manufactured by BYK Chemie; Tego™ Rad 2100, Tego™ Rad 2200N, Tego™ Rad 2250N, Tego™ Rad 2300, Tego™ Rad 2500, Tego™ Rad 2600, Tego™ Rad 2700, and Tego™ RC711 all manufactured by EVONIK. Another preferred silicone is Silwet™ L7500 from OSI SPECIALITIES BENELUX NV; Silaplane™ FM7711, Silaplane™ FM7721, Silaplane™ FM7731, Silaplane™ FM0711, Silaplane™ FM0721, Silaplane™ FM0725, Silaplane™ TM0701, Silaplane™ TM0701T all manufactured by CHISSO Corporation; and DMS-R05, DMS-R11, DMS-R18, DMS-R22, DMS-R31, DMS-U21, DBE-U22, SIB1400, RMS-044, RMS-033, RMS-083, UMS-182, UMS-992, UCS-052, RTT-1011 and UTT-1012 all manufactured by GELEST Inc.

Particularly preferred surfactants for the free radical inkjet ink are Silmer® surfactants from SILTECH CORPORATION, such as Silmer® ACR Di-1508.

### Preparation of UV LED Free Radical Curable Inkjet Inks

The preparation of UV curable inkjet inks is generally well-known to the skilled person.

The average particle size and distribution of a colour pigment is an important feature for inkjet inks. The inkjet ink may be prepared by precipitating or milling the pigment in the dispersion medium in the presence of the dispersant.

Mixing apparatuses may include a pressure kneader, an open kneader, a planetary mixer, a dissolver, and a Dalton Universal Mixer. Suitable milling and dispersion apparatuses are a ball mill, a pearl mill, a colloid mill, a high-speed disperser, double rollers, a bead mill, a paint conditioner, and triple rollers. The dispersions may also be prepared using ultrasonic energy.

Different types of materials may be used as milling media, such as glasses, ceramics, metals, and plastics. In a preferred embodiment, the grinding media can comprise particles, preferably substantially spherical in shape, e.g. beads consisting essentially of a polymeric resin or yttrium stabilized zirconium oxide beads.

In the process of mixing, milling and dispersion, each process is performed with cooling to prevent build up of heat and as much as possible under light conditions in which actinic radiation has been substantially excluded.

The inkjet ink may contain more than one pigment, and may be prepared using separate dispersions for each pigment, or alternatively several pigments may be mixed and co-milled in preparing the dispersion.

The dispersion process can be carried out in a continuous, batch or semi-batch mode.

The preferred amounts and ratios of the ingredients of the mill grind will vary depending upon the specific materials and the intended applications. The contents of the milling mixture comprise the mill grind and the milling media. The mill grind comprises pigment, polymeric dispersant and a liquid carrier. For inkjet inks, the pigment is usually present in the mill grind at 5 to 50 wt %, excluding the milling media. The weight ratio of pigment over polymeric dispersant is preferably 20:1 to 1:2, more preferably 2:1 to 1:1.

The optimal milling time can vary and depends upon the pigment, mechanical means and residence conditions selected, the initial and desired final particle size, etc. In the present invention pigment dispersions with an average particle size of less than 100 nm may be prepared.

After milling is completed, the milling media is separated from the milled particulate product (in either a dry or liquid dispersion form) using conventional separation techniques, such as by filtration, sieving through a mesh screen, and the like. Often the sieve is built into the mill, e.g. for a bead mill. The milled pigment concentrate is preferably separated from the milling media by filtration.

In general, it is desirable to make the Inkjet inks in the form of a concentrated pigment dispersion, which is subsequently diluted to the appropriate concentration for use in the inkjet printing system. This technique permits preparation of a greater quantity of pigmented ink from the equipment. By dilution, the inkjet ink is adjusted to the desired viscosity, surface tension, colour, hue, saturation density, and print area coverage for a particular application.

### Inkjet Devices

An inkjet device according to the present invention preferably includes the above described inkjet ink set and UV LED sources having a spectral emission in the range of 360-420 nm.

The UV LED free radical curable inkjet inks are jetted by print heads ejecting small droplets in a controlled manner through nozzles onto a substrate moving relative to the print head(s). A preferred print head for the inkjet printing system is a piezoelectric head. Piezoelectric inkjet printing is based on the movement of a piezoelectric ceramic transducer when a voltage is applied thereto. The application of a voltage changes the shape of the piezoelectric ceramic transducer in the print head creating a void, which is then filled with inkjet ink or liquid. When the voltage is again removed, the ceramic expands to its original shape, ejecting a drop of ink from the print head. Piezoelectric print heads have proven to be the most reliable print heads in industrial printing.

A preferred piezoelectric print head is a so called push mode type piezoelectric print head, which has a rather large piezo-element capable of ejecting also more viscous inkjet ink droplets. Such a print head is available from RICOH as the GEN5s print head.

Another preferred piezoelectric print head is a so-called through-flow piezoelectric drop-on-demand print head. Such a print head is available from TOSHIBA TEC as the CF1ou print head. Through-flow print heads are preferred because they enhance the reliability of inkjet printing as the ink continuously flows through the print head.

An inkjet print head normally scans back and forth in a transversal direction across the moving ink-receiver surface. Sometimes the inkjet print head does not print on the way back, however bi-directional printing is preferred for obtaining a high areal throughput.

Another preferred inkjet device uses a “single pass printing process”, which can be performed by using page wide inkjet print heads or multiple staggered inkjet print heads that cover the entire width of the substrate surface. In a single pass printing process, the inkjet print heads usually remain stationary and the substrate is transported under the inkjet print heads.

For facilitating curing, the inkjet printer may include one or more oxygen depletion units. The oxygen depletion units place a blanket of nitrogen or other relatively inert gas (e.g. CO₂), with adjustable position and adjustable inert gas concentration, in order to reduce the oxygen concentration in the curing environment. Residual oxygen levels are usually maintained as low as 200 ppm, but are generally in the range of 200 ppm to 1200 ppm.

### Printed Articles

In the present invention, a printed article includes a substrate and one or more UV LED free radical curable inkjet inks as described above.

There is no real limitation on the substrate, but the substrate is preferably a substantially non-absorbing substrate. A substantially non-absorbing substrate is any ink-jet ink-receiver which fulfils at least one of the following two criteria: 1) No penetration of ink into the ink-jet ink-receiver deeper than 2 μm; or 2) No more than 20% of a droplet of 100 pL jetted onto the surface of the ink-jet ink-receiver disappears into the ink-jet ink-receiver in 5 seconds. If one or more coated layers are present, the dry thickness should be less than 5 μm. Standard analytical method can be used by one skilled in the art to determine whether an ink-receiver falls under either or both of the above criteria of a substantially non-absorbing ink-receiver. For example, after jetting ink on the ink-receiver surface, a slice of the ink-receiver can be taken and examined by transmission electron microscopy to determine if the penetration depth of the ink is greater than 2 μm. Further information regarding suitable analytical methods can be found in the article: DESIE, G, et al. Influence of Substrate Properties in Drop on Demand Printing. Proceedings of Imaging Science and Technology's 18th International Conference on Non Impact Printing. 2002, p. 360-365.

Suitable substrates include those having surfaces of metal, like aluminum; polyethylene; polypropylene; polystyrene; polycarbonate; polyvinyl chloride; polyesters like polyethylene terephthalate (PET), glycol-modified polyethylene terephthalate (PETG), polyethylene naphthalate (PEN) and polylactide (PLA); and polyimide.

The substrate is preferably a substrate having a surface selected from the group consisting of polymethylmethacrylate, polyvinylchloride, polyethylene terephthalate, aluminum, and glass. On these often ‘difficult’ substrates, very good adhesion was observed.

The substrates may be transparent, translucent or opaque. Preferred opaque substrates includes so-called synthetic paper, like the Synaps™ grades from Agfa-Gevaert which is an opaque polyethylene terephthalate sheet.

There is no restriction on the shape of the substrate. It can be a flat polymeric board or it can be a three dimensional object like a bottle or a furniture.

### Inkjet Printing Methods

An inkjet printing method according to the present invention preferably includes the steps of: a) jetting a UV LED free radical curable inkjet ink as described above on a substrate; and b) curing the jetted UV LED free radical curable inkjet ink by UV LED sources having a spectral emission in the range of 350-420 nm. The UV curing is preferably performed by UV LEDs having an emission wavelength larger than 360 nm, preferably larger than 370 nm. Any inkjet device as described above may be used for the inkjet printing method.

In a particularly preferred embodiment, the inkjet printing of the UV curable inkjet inks is performed in a multi-pass printing mode. Multi-pass printing is a technique used to reduce banding in ink-jet printing. Dots of ink, when still in liquid form, tend to run together due to surface tension. This is referred to as coalescence. To print a high quality image, it is important to print individual round dots. But to achieve full saturated colours, the dots must overlap to completely cover the substrate. By only printing a portion of the image data so as to avoid simultaneously printing adjacent dots during each printing cycle, coalescence may be largely avoided. Additionally, by avoiding all horizontal adjacencies, the transverse speed of the printing mechanism can be increased up to two times the rated print speed of the print head. In a preferred embodiment, the number of passes used is to 2 to 6 passes, more preferably no more than 4 passes. The printing reliability for multi pass printing is higher than single pass inkjet printing.

An advantage of using a multi-pass printing mode is that the UV curable inkjet inks are cured in consecutive passes, rather than in a single pass requiring a curing device with a high UV output. The print head lifetime is also larger for multi pass printing. While in single pass printing one side shooter is sufficient to replace the whole print head, in multi pass printing side shooters and even failings can be tolerated. Also the cost of a multi-pass printer is usually much lower, especially for wide format substrates.

### EXAMPLES

Measurement methods

### 1. Average Particle Size

The average particle size of pigment particles was determined by photon correlation spectroscopy at a wavelength of 633 nm with a 4 mW HeNe laser on a diluted sample of the pigmented inkjet ink. The particle size analyzer used was a Malvern™ nano-S available from Goffin-Meyvis.

The sample was prepared by addition of one drop of dispersion to a cuvette containing 1.5 mL ethyl acetate and mixed until a homogenous sample was obtained. The measured particle size is the average value of 3 consecutive measurements consisting of 6 runs of 20 seconds.

### 2. Kinematic Viscosity

The kinematic viscosity of the UV LED free radical curable inkjet inks was measured at 45° C. using a HVM472 (UV) multirange viscometer from HERZOG and is expressed in mm²/s.

### 3. Surface Tension

The static surface tension of the UV LED free radical curable inkjet inks was measured with a KRUSS tensiometer K9 from KRUSS GmbH, Germany at 25° C. after 60 seconds.

### 4. Stickiness

The stickiness of a UV LED free radical curable inkjet ink was determined by printing in “Quality mode” a 13 cm×19 cm square at 100% ink coverage in 720×720 dpi resolution with an Anapurna™ 2050i LED from AGFA on a MultiArt™ gloss substrate from PAPYRUS.

The printed sample is stapled with unprinted MultiArt™ gloss substrate and kept in an oven for 24 hours under a weight of 4.85 kg at 25° C. and 95% relative humidity. Afterwards the amount of transfer of ink to the backside an unprinted MultiArt™ gloss substrate is examined and given a score according to Table 2.

TABLE 2

| Score | Observation |
|---|---|
| A | No ink transfer visible |
| B | A very small amount of ink (some dots) is transferred to the |
| | backside of an unprinted MultiArt ™ gloss substrate |
| C | Substantial ink transfer is clearly visible |
| D | Very large amounts of ink are transferred, even the shape of |
| | the printed square is visible |

### 5. Adhesion

A 10 cm×10 cm square at 100% ink coverage of the UV LED free radical curable inkjet ink was printed in “Quality mode” at 720×1440 dpi resolution with an Anapurna™ 2050i LED from AGFA on 4 different substrates: Barlo™ XT, Biprint™, Vikuglas™ and white Metamark™.

The Adhesion was tested on each colour square using a cross hatch cutter set Elcometer™ 1542. The distance between the applied scratches is 1 mm. A 5 cm long strip of Tesatape™ 4104 PVC tape was pressed on to the cross cut inkjet ink. The tape was pressed four times with the thumb before removing it in one sharp pull. The adhesion was then evaluated in accordance with the evaluation values described in Table 3.

TABLE 3

| Evalua- | |
|---|---|
| tion | |
| value | Observation |
| 0 | Nothing removed |
| 1 | Detachment of only very small parts of the inkjet ink coating |
| 2 | Minor parts of the inkjet ink coating was removed by the tape |
| 3 | Parts of the inkjet ink coating were removed by the tape |
| 4 | Most of the inkjet ink coating was removed by the tape. |
| 5 | The inkjet ink was completely removed from the substrate by the |
| | tape. |

The sum of the adhesion evaluation values for the 4 different substrates was made and a score was given according to Table 4.

TABLE 4

| | Sum of | |
|---|---|---|
| Score | Evaluation values | Observation |
| A | <5 | Very good to perfect adhesion. |
| B | 6-10 | Good adhesion |
| C | 11-15 | Poor adhesion. |
| D | >15 | Very poor to no adhesion. |

### 6. Scratch Resistance

A 10 cm×10 cm square at 100% ink coverage of the UV LED free radical curable inkjet ink was printed in “Quality mode” at 720×1440 dpi resolution with an Anapurna™ 2050i LED from AGFA on two different substrates: Dibond™ and Lexan™ substrates

A cotton swab (Q-tip) is attached under a weight of 1 kg and repeatedly swiped over a distance of 3 cm on the printed sample. The number of swipes necessary to damage the printed ink layer is recorded for each printed sample substrate and an average is made for the two substrates. A score is attributed according to Table 5.

TABLE 5

| Score | Average | Observation |
|---|---|---|
| A | >500 | Perfect scratch resistance. |
| B | 200-500 | Good scratch resistance. |
| C | 100-200 | Poor scratch resistance. |
| D | <100 | Very poor scratch resistance. |

### Materials

All materials used in the following examples were readily available from standard sources such as Aldrich Chemical Co. (Belgium) and Acros (Belgium) unless otherwise specified. Any water used was demineralized water.

PB15:4 is an abbreviation used for Heliogen™ Blue D 7110 F, a C.I. Pigment Blue 15:4 pigment from BASF.

DB162 is an abbreviation used for the polymeric dispersant Disperbyk™ 162 available from BYK CHEMIE GMBH whereof the solvent mixture of 2-methoxy-1-methylethylacetate, xylene and n-butylacetate was removed. The polymeric dispersant is a polyester-polyurethane dispersant on the basis of caprolacton and toluene diisocyanate having an amine value of 13 mg KOH/g, a Mn of about 4,425 and a Mw of about 6,270.

V-MOX is a Vinyl methyl oxazolidinone (CAS No.: 3395-98-0) available as VMOX™ from BASF.

VCL is N-vinyl caprolactam available from BASF BELGIUM, NV.

IDA is isodecyl acrylate available as Sartomer™ SR395 from ARKEMA.

PEA is 2-phenoxyethyl acrylate available as Sartomer™ SR339C from ARKEMA.

CN131B is 2-hydroxy-3-phenoxypropylacrylate available as Sartomer™ CN131B from ARKEMA.

TBCH is 4-tert.butylcyclohexylacrylate available under the trade name of Sartomer™ SR217 from ARKEMA.

DPGDA is dipropyleneglycoldiacrylate available as Laromer™ DPGDA from BASF.

HDDA is 1,6 hexanediol diacrylate available as Sartomer© SR238 from ARKEMA.

CN104 is a difunctional epoxy acrylate oligomer available as Sartomer™ CN104 from ARKEMA.

ITX is Omnirad™ ITX is an isomeric mixture of 2- and 4-isopropyl thioxanthone from IGM RESINS.

TPO is trimethylbenzoyl diphenyl phosphine oxide supplied as Omnirad™ TPO by IGM RESINS.

UV10 is 4-hydroxy-2,2,6,6-tetramethylpiperidinooxy sebacate available as from Shanghai FINC Chemical Technology Co., Ltd.

INHIB is a mixture forming a polymerization inhibitor having a composition according to Table 6.

TABLE 6

| Component | wt % |
|---|---|
| VEEA | 82.4 |
| p-methoxyphenol | 4.0 |
| Butylated hydroxytoluene (BHT) | 10.0 |
| Cupferron ™ AL | 3.6 |

Cupferron™ AL is aluminum N-nitrosophenylhydroxylamine from WAKO CHEMICALS LTD.

Silwax is a polysiloxane surfactant available as SILWAX B1116 from SILTECH CORPORATION.

Barlo™ XT is a 2 mm thick polymethylmethacrylate substrate from available from ANTALIS.

Biprint™ is 3.4 mm thick corrugated polypropylene substrate available from ANTALIS.

Vikuglas™ is a 3 mm thick extruded polymethylmethacrylate substrate from available from VINK NV.

White Metamark™ is a 225 μm thick PVC foil from METAMARK.

Dibond™ is a 2 mm thick aluminum metal plate.

Lexan™ is a 4 mm thick transparent polycarbonate plate available as Lexan™ SG305 from VINK NV.

### Example 1

This example illustrates the improved adhesion and scratch resistance obtained with UV LED free radical curable inkjet inks according to the invention, while obtaining good surface cure (low stickiness) by UV LED curing.

### Preparation of Concentrated Pigment Dispersions

A concentrated cyan pigment dispersion CPC was prepared by mixing its components according to Table 7 for 30 minutes using a DISPERLUX™ disperser from DISPERLUX S.A.R.L., Luxembourg. The dispersion was then milled using a Bachofen DYNOMILL ECM mill filled with 0.4 mm yttrium stabilized zirconia beads from TOSOH. The mixture was circulated over the mill for 2 hours. After milling, the concentrated pigment dispersion was discharged over a 1 μm filter into a vessel. The concentrated pigment dispersion GPC had an average particle of 85 nm.

TABLE 7

| wt % of: | CPC |
|---|---|
| PB15:4 | 25.0 |
| DB162 | 10.0 |
| INHIB | 1.0 |
| PEA | 64.0 |

### Preparation of Inkjet Inks

The above prepared concentrated dispersion GPO was used to prepare the cyan inkjet inks COMP-1 to COMP-25 and INV-1 to INV-5 according to Table 9 to Table 12.

TABLE 9

| Ink | COMP-1 | COMP-2 | COMP-3 | COMP-4 | COMP-5 | COMP-6 | COMP-7 | COMP-8 |
|---|---|---|---|---|---|---|---|---|
| PB15:4 | 2.00 | 2.00 | 2.00 | 2.00 | 2.00 | 2.00 | 2.00 | 2.00 |
| DB162 | 0.80 | 0.80 | 0.80 | 0.80 | 0.80 | 0.80 | 0.80 | 0.80 |
| V-MOX | 17.80 | 17.80 | 18.70 | 18.70 | 19.55 | 22.10 | 19.55 | 20.90 |
| VCL | 13.00 | 13.00 | 13.00 | 13.00 | 13.00 | 13.40 | 13.00 | 13.45 |
| IDA | | | | 1.05 | 6.07 | 6.60 | 6.07 | 7.62 |
| PEA | 19.12 | 19.12 | 11.82 | 8.22 | 6.80 | 6.62 | 6.80 | 11.70 |
| CN131B | 19.69 | 19.69 | 19.69 | 19.69 | 19.69 | 19.69 | 19.69 | 19.69 |
| TBCH | 1.90 | 1.90 | | | | | | |
| IBOA | 12.40 | 12.40 | 20.70 | 20.70 | 18.80 | 15.50 | 18.80 | 8.00 |
| HDDA | | | | 2.55 | | | | 2.55 |
| CN104 | 1.80 | 1.80 | 1.80 | 1.80 | 1.80 | 1.80 | 1.80 | 1.80 |
| TPO | 9.19 | 9.19 | 9.19 | 9.19 | 9.19 | 9.19 | 9.19 | 9.19 |
| ITX | 0.50 | 0.50 | 0.50 | 0.50 | 0.50 | 0.50 | 0.50 | 0.50 |
| Silwax | 0.50 | 0.50 | 0.50 | 0.50 | 0.50 | 0.50 | 0.50 | 0.50 |
| UV10 | 0.30 | 0.30 | 0.30 | 0.30 | 0.30 | 0.30 | 0.30 | 0.30 |
| INHIB | 1.00 | 1.00 | 1.00 | 1.00 | 1.00 | 1.00 | 1.00 | 1.00 |

TABLE 10

| Ink | COMP-9 | COMP-10 | COMP-11 | COMP-12 | COMP-13 | COMP-14 | COMP-15 | COMP-16 |
|---|---|---|---|---|---|---|---|---|
| PB15:4 | 2.00 | 2.00 | 2.00 | 2.00 | 2.00 | 2.00 | 2.00 | 2.00 |
| DB162 | 0.80 | 0.80 | 0.80 | 0.80 | 0.80 | 0.80 | 0.80 | 0.80 |
| V-MOX | 16.70 | 19.70 | 13.55 | 19.55 | 19.74 | 19.59 | 19.55 | 15.05 |
| VCL | 13.00 | 13.00 | 13.00 | 13.00 | 13.40 | 13.00 | 13.00 | 12.75 |
| IDA | 1.77 | 10.23 | 4.11 | 6.07 | 0.50 | 5.98 | 6.07 | |
| PEA | 16.25 | 6.41 | 18.99 | 6.80 | 11.83 | 16.54 | 6.80 | 8.57 |
| CN131B | 19.69 | 19.69 | 19.69 | 19.69 | 19.69 | 19.69 | 19.69 | 19.69 |
| TBCH | | | | | | | | 5.65 |
| IBOA | 18.30 | 14.88 | 16.37 | 18.80 | 20.55 | 10.91 | 18.80 | 24.00 |
| CN104 | 0.00 | 1.80 | 0.00 | 1.80 | 0.00 | 0.00 | 1.80 | 0.00 |
| TPO | 9.19 | 9.19 | 9.19 | 9.19 | 9.19 | 9.19 | 9.19 | 9.19 |
| ITX | 0.50 | 0.50 | 0.50 | 0.50 | 0.50 | 0.50 | 0.50 | 0.50 |
| Silwax | 0.50 | 0.50 | 0.50 | 0.50 | 0.50 | 0.50 | 0.50 | 0.50 |
| UV10 | 0.30 | 0.30 | 0.30 | 0.30 | 0.30 | 0.30 | 0.30 | 0.30 |
| INHIB | 1.00 | 1.00 | 1.00 | 1.00 | 1.00 | 1.00 | 1.00 | 1.00 |

TABLE 11

| Ink | COMP-17 | COMP-18 | COMP-19 | COMP-20 | COMP-21 | COMP-22 | COMP-23 | COMP-24 |
|---|---|---|---|---|---|---|---|---|
| PB15:4 | 2.00 | 2.00 | 2.00 | 2.00 | 2.00 | 2.00 | 2.00 | 2.00 |
| DB162 | 0.80 | 0.80 | 0.80 | 0.80 | 0.80 | 0.80 | 0.80 | 0.80 |
| V-MOX | 15.75 | 12.95 | 12.55 | 13.05 | 11.30 | | 1.10 | 1.54 |
| VCL | 13.00 | 11.00 | 11.00 | 11.00 | 11.00 | 5.68 | 13.00 | 13.00 |
| IDA | 3.83 | | | | | | | |
| PEA | 9.52 | 34.13 | 33.75 | 34.97 | 33.75 | 25.55 | 10.06 | 6.41 |
| CN131B | 19.69 | 9.00 | 9.00 | 9.00 | 9.00 | 9.00 | 9.00 | 9.00 |
| TBCH | | | | | | 12.00 | 15.00 | 15.00 |
| IBOA | 19.57 | 16.00 | 16.78 | 15.56 | 17.07 | 26.85 | 35.60 | 39.18 |
| HDDA | 2.55 | 0.83 | 0.83 | 0.33 | 1.79 | | 0.15 | |
| DPGDA | | | | | | 4.83 | | |
| CN104 | 1.80 | 1.80 | 1.80 | 1.80 | 1.80 | 1.80 | 1.80 | 1.58 |
| TPO | 9.19 | 9.19 | 9.19 | 9.19 | 9.19 | 9.19 | 9.19 | 9.19 |
| ITX | 0.50 | 0.50 | 0.50 | 0.50 | 0.50 | 0.50 | 0.50 | 0.50 |
| Silwax | 0.50 | 0.50 | 0.50 | 0.50 | 0.50 | 0.50 | 0.50 | 0.50 |
| UV10 | 0.30 | 0.30 | 0.30 | 0.30 | 0.30 | 0.30 | 0.30 | 0.30 |
| INHIB | 1.00 | 1.00 | 1.00 | 1.00 | 1.00 | 1.00 | 1.00 | 1.00 |

TABLE 12

| Ink | COMP-25 | INV-1 | INV-2 | INV-3 | INV-4 | INV-5 |
|---|---|---|---|---|---|---|
| PB15:4 | 2.00 | 2.00 | 2.00 | 2.00 | 2.00 | 2.00 |
| DB162 | 0.80 | 0.80 | 0.80 | 0.80 | 0.80 | 0.80 |
| V-MOX | 13.05 | 13.28 | 13.35 | 16.55 | 13.65 | 14.10 |
| VCL | 13.00 | 13.00 | 13.00 | 13.10 | 11.00 | 13.00 |
| IDA | | 8.08 | | 5.50 | | |
| PEA | 35.59 | 8.14 | 8.14 | 7.27 | 23.72 | 25.30 |
| CN131B | 9.00 | 19.69 | 19.69 | 19.69 | 9.00 | 9.00 |
| TBCH | | | 3.18 | | | |
| IBOA | 12.27 | 19.17 | 24.00 | 21.80 | 25.54 | 21.51 |
| HDDA | | 2.55 | 1.55 | | 1.00 | |
| DPGDA | | | 1.00 | | | |
| CN104 | 2.80 | 1.80 | 1.80 | 1.80 | 1.80 | 2.80 |
| TPO | 9.19 | 9.19 | 9.19 | 9.19 | 9.19 | 9.19 |
| ITX | 0.50 | 0.50 | 0.50 | 0.50 | 0.50 | 0.50 |
| Silwax | 0.50 | 0.50 | 0.50 | 0.50 | 0.50 | 0.50 |
| UV10 | 0.30 | 0.30 | 0.30 | 0.30 | 0.30 | 0.30 |
| INHIB | 1.00 | 1.00 | 1.00 | 1.00 | 1.00 | 1.00 |

### Evaluation and Results

The cyan inkjet inks COMP-1 to COMP-25 and INV-1 to INV-5 were evaluated for stickiness, adhesion and scratch resistance. The kinematic viscosity of each inkjet ink was also determined and expressed in mm²/s. All results are shown in Table 13. The surface tension is not shown, but all inkjet inks were measured to have a surface tension between 26 and 30 mN/in at 2500.

TABLE 13

| | wt % | Content | | | | Scratch | Kinematic |
|---|---|---|---|---|---|---|---|
| Ink | VMOX | monofunctional | DD | Stickiness | Adhesion | resistance | Viscosity |
| COMP-1 | 17.8 | 97% | 5.80 | A | B | D | 8.0 |
| COMP-2 | 17.8 | 97% | 5.80 | A | A | D | 8.0 |
| COMP-3 | 18.7 | 97% | 5.80 | A | A | D | 8.0 |
| COMP-4 | 18.7 | 94% | 5.90 | A | C | D | 7.8 |
| COMP-5 | 19.6 | 97% | 5.80 | A | A | C | 7.4 |
| COMP-6 | 22.1 | 97% | 5.90 | A | A | D | 7.2 |
| COMP-7 | 19.6 | 97% | 5.80 | A | B | D | 7.4 |
| COMP-8 | 20.9 | 94% | 6.00 | A | C | D | 7.1 |
| COMP-9 | 16.7 | 99% | 5.80 | A | A | D | 7.2 |
| COMP-10 | 19.7 | 97% | 5.80 | D | B | C | 7.1 |
| COMP-11 | 13.6 | 99% | 5.70 | D | B | D | 7.2 |
| COMP-12 | 19.6 | 97% | 5.80 | A | A | D | 7.5 |
| COMP-13 | 19.7 | 99% | 5.90 | A | A | D | 7.2 |
| COMP-14 | 19.6 | 99% | 5.90 | D | B | D | 6.7 |
| COMP-15 | 19.6 | 97% | 5.80 | B | B | C | 7.4 |
| COMP-16 | 15.1 | 99% | 5.70 | B | B | D | 7.6 |
| COMP-17 | 15.8 | 94% | 5.80 | A | D | A | 7.7 |
| COMP-18 | 13.0 | 96% | 5.72 | B | B | C | 6.5 |
| COMP-19 | 12.6 | 96% | 5.70 | B | A | C | 6.5 |
| COMP-20 | 13.1 | 97% | 5.70 | B | A | C | 6.2 |
| COMP-21 | 11.3 | 95% | 5.70 | C | A | C | 6.6 |
| COMP-22 | 0.0 | 91% | 5.20 | A | A | C | 7.3 |
| COMP-23 | 1.1 | 97% | 5.20 | A | A | C | 7.7 |
| COMP-24 | 1.5 | 97% | 5.20 | A | A | C | 7.7 |
| COMP-25 | 13.1 | 96% | 5.71 | D | B | C | 6.9 |
| INV-1 | 13.3 | 94% | 5.70 | B | B | A | 7.5 |
| INV-2 | 13.4 | 94% | 5.70 | A | B | B | 8.4 |
| INV-3 | 16.6 | 97% | 5.70 | B | B | A | 7.6 |
| INV-4 | 13.7 | 96% | 5.70 | A | A | B | 6.5 |
| INV-5 | 14.1 | 96% | 5.70 | A | B | A | 6.8 |

From Table 13, it can be seen that only the inkjet inks INV-1 to INV-5 having a content of vinyl methyl oxazolidinone (VMOX) of at least 13.3 wt %, a content of monofunctional polymerizable compounds between 84 and 98 wt % and a double bond density DD between 5.28 and 5.78 mmol double bonds/g exhibit good stickiness, adhesion and scratch resistance.

1-15. (canceled)

16. A UV LED free radical curable inkjet ink containing
(i) a colour pigment;
(ii) an acylphosphine oxide photoinitiator;
(iii) monofunctional polymerizable compounds including vinyl methyl oxazolidinone; and
(iv) one or more polyfunctional polymerizable compounds, wherein
the double bond density DD is between 5.28 and 5.78 mmol double bonds/g; the content of monofunctional polymerizable compounds is between 84 and 98 wt % based on the total weight of the polymerizable composition; and
the content of vinyl methyl oxazolidinone is at least 13.3 wt % based on the total weight of the UV LED free radical curable inkjet ink, and
wherein the double density DD is calculated by the formula:
$$D D = \frac{{\sum }_{i = 1 to n}^{n} \frac{F ( i ) \times wt \% ( i )}{M W ( i )}}{{\sum }_{i = 1 to n}^{n} wt \% ( i )} ,$$
wherein n represents the number of monomers and oligomers in the UV LED free radical curable inkjet ink; F(i) represents the functionality of monomer or oligomer i; MW(i) represents the molecular weight of monomer or oligomer i; and wt % (i) is the weight percentage of monomer or oligomer i based on the total weight of the polymerizable composition.

17. The UV LED free radical curable inkjet ink of claim 16, wherein the double bond density DD is between 5.65 and 5.75 mmol double bonds/g.

18. The UV LED free radical curable inkjet ink of claim 16, wherein the content of monofunctional monomers between 90 and 97 wt % based on the total weight of the UV LED free radical curable inkjet ink.

19. The UV LED free radical curable inkjet ink of claim 16, wherein the UV LED free radical curable inkjet ink contains N-vinylcaprolactam.

20. The UV LED free radical curable inkjet ink of claim 19, wherein the content of vinyl methyl oxazolidinone and N-vinylcaprolactam is at least 20 wt % based on the total weight of the UV LED free radical curable inkjet ink.

21. The UV LED free radical curable inkjet ink of claim 16, wherein the acylphosphine oxide photoinitiator includes an acyl group containing a polymerizable group or an acyl group selected from the group consisting of a benzoyl group substituted by an urea group or an oxalylamide group; a 2,6-dimethyl benzoyl group substituted in position 3 by an urea group or an oxalylamide group; a 2,6-dimethoxy benzoyl group substituted in position 3 by an urea group or an oxalylamide group; a 2,4,6-trimethyl benzoyl group substituted in position 3 by an urea group or an oxalylamide group; and a 2,4,6-trimethoxybenzoyl group substituted in position 3 by an urea group or an oxalylamide group.

22. The UV LED free radical curable inkjet ink of claim 16, wherein the acylphosphine oxide photoinitiator is present in an amount of at least 3 wt % based on the total weight of the UV LED free radical curable inkjet ink.

23. The UV LED free radical curable inkjet ink of claim 16, wherein the UV LED free radical curable inkjet ink contains 10 to 23 wt % of isobornyl acrylate based on the total weight of the UV LED free radical curable inkjet ink.

24. The UV LED free radical curable inkjet ink of claim 16, wherein the UV LED free radical curable inkjet ink contains more than 42 wt % of isobornyl acrylate and phenoxyethyl acrylate based on the total weight of the UV LED free radical curable inkjet ink.

25. The UV LED free radical curable inkjet ink of claim 16, wherein the kinematic viscosity of the inkjet ink is between 4 and 12 mm²/s as measured at 45° C.

26. The UV LED free radical curable inkjet ink of claim 16, wherein the organic colour pigment is a beta-copper phthalocyanine pigment.

27. An inkjet ink set including the UV LED free radical curable inkjet ink of claim 26 and further including at least a black UV LED free radical curable inkjet ink containing a carbon black pigment; a magenta or red UV LED free radical curable inkjet ink containing a quinacridone pigment, a diketopyrrolopyrrole pigment or mixed crystals thereof; and a yellow UV LED free radical curable inkjet ink containing a yellow pigment selected from the group consisting of C.I. Pigment Yellow 83, C.I. Pigment Yellow 93, C.I. Pigment Yellow 97, C.I. Pigment Yellow 110, C.I. Pigment Yellow 120, C.I. Pigment Yellow 138,C.I. Pigment Yellow 150, C.I. Pigment Yellow 151, C.I. Pigment Yellow 154, C.I. Pigment Yellow 155, C.I. Pigment Yellow 175, C.I. Pigment Yellow 180, C.I. Pigment Yellow 181, C.I. Pigment Yellow 185, C.I. Pigment Yellow 194, C.I. Pigment Yellow 213, C.I. Pigment Yellow 214, and mixed crystals thereof.

28. A printed article including a substrate and the UV LED free radical curable inkjet ink of claim 16, wherein the substrate is a substrate having a surface selected from the group consisting of polymethylmethacrylate, polyvinylchloride, polyethylene terephthalate, aluminum, and glass.

29. An inkjet device including the inkjet ink set of claim 27 and UV LED sources having a spectral emission in the range of 360-420 nm.

30. An inkjet printing method including the steps of:
a) jetting a UV LED free radical curable inkjet ink as claimed in claim 16 on a substrate; and
b) curing the jetted UV LED free radical curable inkjet ink by UV LED sources having a spectral emission in the range of 360-420 nm.

31. A printed article including a substrate and the UV LED free radical curable inkjet ink of claim 19, wherein the substrate is a substrate having a surface selected from the group consisting of polymethylmethacrylate, polyvinylchloride, polyethylene terephthalate, aluminum, and glass.

32. A printed article including a substrate and the UV LED free radical curable inkjet ink of claim 26, wherein the substrate is a substrate having a surface selected from the group consisting of polymethylmethacrylate, polyvinylchloride, polyethylene terephthalate, aluminum, and glass.

33. An inkjet printing method including the steps of:
a) jetting a UV LED free radical curable inkjet ink as claimed in claim 19 on a substrate; and
b) curing the jetted UV LED free radical curable inkjet ink by UV LED sources having a spectral emission in the range of 360-420 nm.

34. An inkjet printing method including the steps of:
a) jetting a UV LED free radical curable inkjet ink as claimed in claim 26 on a substrate; and
b) curing the jetted UV LED free radical curable inkjet ink by UV LED sources having a spectral emission in the range of 360-420 nm.
